(19) United States
(12) Patent Application Publication
(10) Pub. No.: US 2012/0120196 A1
(43) Pub. Date: May 17, 2012

(54) IMAGE COUNTING METHOD AND APPARATUS

(76) Inventors: Chi-Hung Tsai, Taichung City (TW); Bo-Fu Liu, Nansi Township (TW); Chien-Chung Chiu, Luodong Township (TW); Yeh-Kuang Wu, Linkou Township (TW)

(21) Appl. No.: 12/971,826

(22) Filed: Dec. 17, 2010

(30) Foreign Application Priority Data
Nov. 15, 2010 (TW) 99139182

(51) Int. Cl. H04N 13/02; G06K 9/00

(52) U.S. Cl. 348/46; 382/154; 348/E13.074

(57) ABSTRACT

The image counting method includes the steps of: acquiring 3D images from the region by a 3D camera, wherein the 3D images include a plurality of pixels, and the pixels have x, y and z coordinate values and pixel data; mapping the x, y and z coordinate values and the pixel data of the pixels into a plurality of correlative coordinate values of a spatial correlative coordinate represented as (x, z, t), wherein t is the number of pixels whose pixel data are lower than a threshold in y direction with the same x and z coordinate values; grouping the correlative coordinate values into a plurality of groups according to a correlation between each of the correlative coordinate values in x-z plane; and comparing the correlative coordinate values of each of groups with the correlative coordinate values of the 3D images of the specific objects to determine the number of specific objects in the region.

### CROSS REFERENCE TO RELATED APPLICATIONS

This Non-provisional application claims priority under 35 U.S.C. §119(a) on Patent Application No(s). 99139182, filed in Taiwan, Republic of China on Nov. 15, 2010, the entire contents of which are hereby incorporated by reference.

### BACKGROUND OF THE INVENTION

1. Field of the Invention

The present invention relates to image processing techniques, and in particular relates to apparatuses and methods for counting specific objects in 3D images.

2. Description of the Related Art

In the image processing field, how to use camera systems, to count specific objects, such as human beings or vehicles, in an observation area, has become an important topic.

The prior art uses 2D photography systems to perform image processing. The 2D photography system has to distinguish the foreground from the background of an observable area before counting. After subtracting the background, the number of objects in the foreground can be counted by using image processing techniques. However, to distinguish between the foreground and the background can be extremely difficult if the images of background are complex, or the images shot are severely shaken. In addition, the objects in a 2D image shot by the 2D photography system usually overlap with each other, such that it is near impossible to perform precise counting.

Therefore, a new image counting method and apparatus able to count objects in images more efficiently and precisely are needed.

### BRIEF SUMMARY OF THE INVENTION

An image counting method for counting the number of specific objects in a region is provided. The image counting method comprises the steps of: acquiring a 3D image from the region by a 3D camera, wherein the 3D images comprise a plurality of pixels, and the pixels have x, y and z coordinate values and pixel data; mapping the x, y and z coordinate values and the pixel data of the pixels to a plurality of correlative coordinate values of a spatial correlative coordinate represented as (x, z, t), wherein t is the number of pixels whose pixel data are lower than a threshold in y direction with the same x and z coordinate values; grouping the correlative coordinate values into a plurality of groups according to a correlation between each of the correlative coordinate values in x-z plane; and comparing the correlative coordinate values of each of groups with the correlative coordinate values of the 3D images of the specific objects to determine the number of specific objects in the region.

An image counting apparatus for counting the number of specific objects in a region is provided. The image counting apparatus comprises a 3D camera for acquiring a 3D image from the region, wherein the 3D images comprise a plurality of pixels, and the pixels have x, y and z coordinate values and pixel data; and a processor, coupled to the 3D camera, comprising: a mapping unit for mapping the x, y and z coordinate values and the pixel data of the pixels to a plurality of correlative coordinate values of a spatial correlative coordinate represented as (x, z, t), wherein t is the number of pixels whose pixel data are lower than a threshold in y direction with the same x and z coordinate values; a grouping unit for the correlative coordinate values into a plurality of groups according to a correlation between each of the correlative coordinate values in x-z plane; and a comparing unit for comparing the correlative coordinate values of each of groups with the correlative coordinate values of the 3D images of the specific objects to determine the number of specific objects in the region.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is the flowchart of the image counting method according to an embodiment of the present invention.

FIG. 2 is a diagram showing an embodiment of the 3D camera to illustrate step S102.

FIGS. 3A, 3B and 3C are diagrams illustrating step S104 of establishing a spatial correlative coordinate (x, z, t).

FIG. 4 is a schematic diagram of the image counting apparatus according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

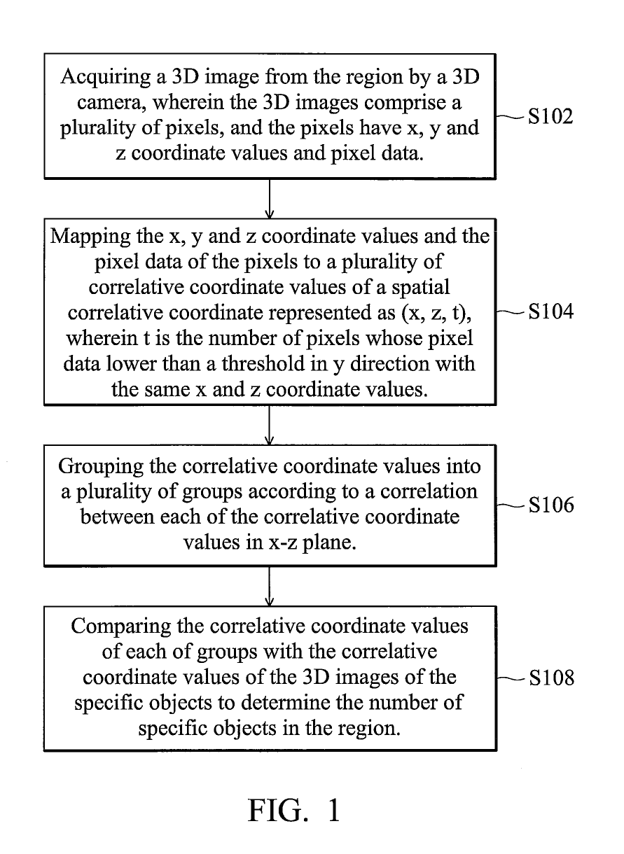

FIG. 1 is the flowchart of the image counting method according to an embodiment of the present invention. The image counting method is used to count the number of specific objects in a region and comprises: in step S102, acquiring a 3D image from the region by a 3D camera, wherein the 3D images comprise a plurality of pixels, and the pixels respectively have x, y and z coordinate values and pixel information; in step S104, mapping the x, y and z coordinate values and the pixel data of the pixels to a plurality of correlative coordinate values of a spatial correlative coordinate represented as (x, z, t), wherein t is the number of pixels whose pixel data are lower than a threshold in y direction at the same (x, z) coordinate values; in step S106, grouping the correlative coordinate values into a plurality of groups according to a correlation between each of the correlative coordinate values in x-z plane; and in step S108, comparing the correlative coordinate values of each of groups with the correlative coordinate values of the 3D images of the specific objects to determine the number of specific objects in the region. In most cases application of the image counting method is for people counting. Thus, the specific objects in the following embodiments will be human beings. However, those skilled in the art will appreciate that the present invention should not be limited thereto. The image counting method of the present invention will be discussed in the following.

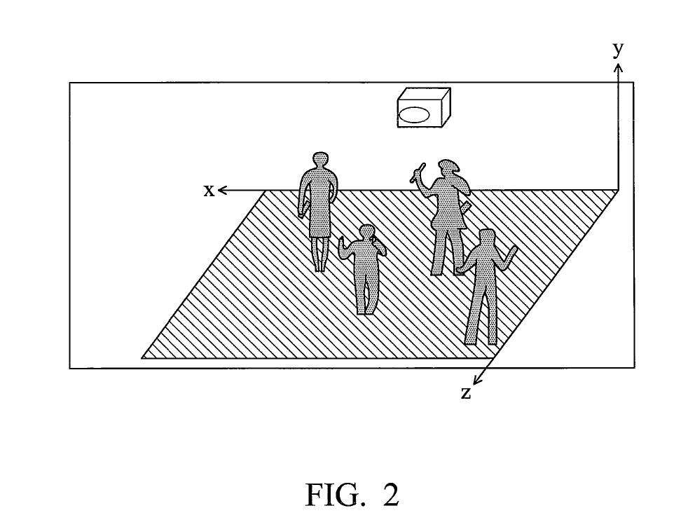

FIG. 2 is a diagram showing an embodiment of the 3D camera to illustrate step S102. Different from the 2D photography technique, the present invention employs the 3D camera to acquire 3D images of every object, and further acquires x, y, z coordinates and pixel data of a plurality of pixels in the 3D image. The 3D camera may use 3D cameras, or depth cameras able to obtain spatial coordinates of objects with infrared light or laser. In various embodiments, the camera lens may be disposed around or integrated into a display for obtaining the spatial coordinate of a user facing the display. Taking FIG. 2 for example, the z coordinate therein usually represents the depth of an object (distance between the object and the camera) in the region. The x and y coordinates are normal to the z coordinate. In the following embodiments, the y-axle is parallel with the direction of gravity. In other embodiments, the direction of the x, y and z-axle may be independently defined by users and should not be limited to the described embodiments.

Generally, the pixel data can be RGB values (value of Red color channel, value of Green color channel, and value of Blue color channel) or gray level values obtained by mapping from the RGB values. mapping from the RGB values, for example, means to average or power average the Red value, Green value, and Blue value. For example, the brightness value I in HIS color region is the average of the Red value, Green value, and Blue value (I=(R+G+B)/3). For power averaging, three different powers are respectively given to the Red value, Green value, and Blue value. For example, the brightness value Y in YCbCr color region can be obtained as follows: Y=0.299R+0.587G+0.144B.

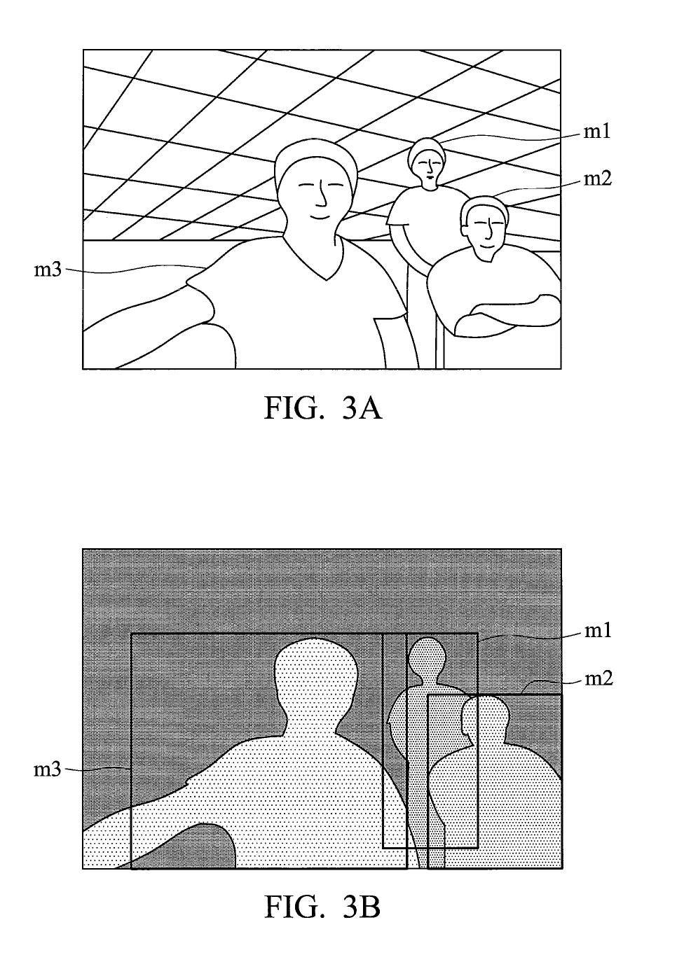

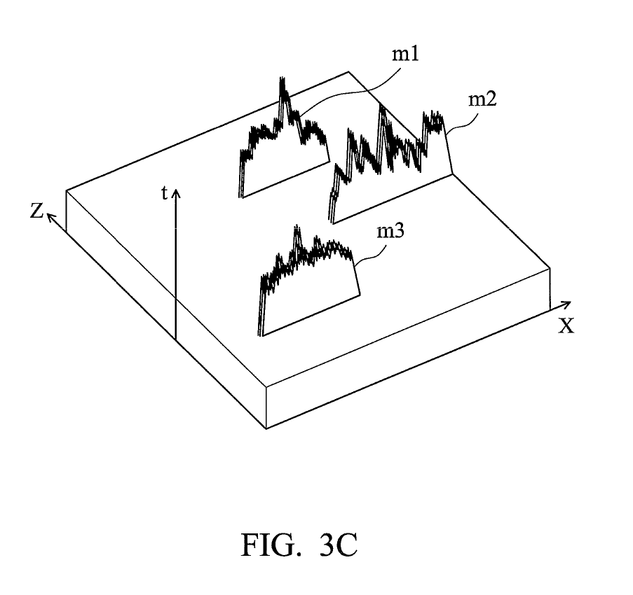

FIGS. 3A, 3B and 3C are diagrams illustrating step S104 of establishing a spatial correlative coordinate (x, z, t). The term “t” represents the number of pixels at the same coordinate value (x, z) which have pixel data lower than a threshold in a y direction. For example, when the pixel data represents the gray level values, step S104 counts the number of pixels at the same coordinate value (x, z) which have gray levels value larger than zero. For another example, when pixel data is the RGB value, step S104 counts the number of pixels at the same coordinate value (x, z) which have power-averaged RGB values larger than zero (the power average procedure has been discussed previously).

FIG. 3A is a 2D image showing three specific objects (i.e., three persons in this embodiment) m1, m2 and m3 which are respectively away from the camera from a far point to a near point. In addition to these three specific objects, other objects and backgrounds are shown in FIG. 3A. In this embodiment, the pixel data is the RGB value. FIG. 3B shows images of FIG. 3A with a gray level, where the gray level values in FIG. 3B can be obtained by gray-scaling the RGB value based on the previously described technique. In FIG. 3B, the darkest area corresponds to the background, the less darkest area corresponds to the person m1 who is farthest away from the camera and has the highest z coordinate, the slightly bright area corresponds to the person m2 who is second farthest from the camera and has the second highest z coordinate, and the brightest area corresponds to the person m3 who is closest to the camera and has the lowest z value. The step S104 counts the number of pixels at the same (x, z) having pixel data lower than a threshold in a y direction and thus obtains a plurality of correlative coordinate values of a spatial correlative coordinate represented as (x, z, t). FIG. 3C shows the spatial correlative coordinate (x, z, t) of FIG. 3A. In other embodiments, t coordinates in the spatial correlative coordinate may be normalized in advance.

In this embodiment, because the specific objects are human beings and human beings may have various poses, such as a standing pose, a sitting pose and a walking pose, the present invention may further record the correlation coordinate of the 3D images of the specific objects of various poses in advance. Thus, a database for recording the data may be provided in this embodiment. In this embodiment, the present invention processes the pixel data along the y direction (parallel with the direction of gravity), but the present invention is not limited thereto in other embodiments.

In another embodiment, the comparing step S108 further comprises the step of mapping the correlative coordinate values of the groups to a plurality of 2D correlative coordinate values of a 2D correlation coordinate represented as (x, t) by, for example, removing the z coordinate and then comparing the 2D correlative coordinate values of the groups with the 2D correlative coordinate values of the specific objects to determine the number of specific objects in the region. Specifically, whether a group corresponds to the specific objects can be determined based on the likeness of the 2D correlative coordinate values thereof, wherein the 2D correlative coordinate values of the specific objects are mapped from the correlative coordinate values of the specific objects and are represented as (x, t). For example, the shape, the size, or the style of deformation of the patterns of the groups in the 2D correlation coordinates. Finally, the present method counts the groups which are determined corresponding to the specific objects as the number of specific objects.

From FIGS. 3B and 3C, those skilled in the art can understand step S106 of grouping the correlative coordinate values into a plurality of groups according to a correlation between each of the correlative coordinate values in the present invention. Specifically, step S106 may group together two correlative coordinate values which have a correlation which is larger than a predetermined value into a same group, or separate two correlative coordinate values which have a correlation lower than the predetermined value into two different groups, and repeating the procedures until all correlative coordinate values are grouped together. Those skilled in the art may employ various algorithms such as Kmeans, KNN (K-nearest neighbor), or FCM (Fuzzy Cmeans) to group the pixels of various correlative coordinate values according to the spirit of the present invention, and these techniques are not discussed further for brevity. Although the specific objects m1 and m2 look like they overlap with each other in FIG. 3A, a 2D diagram, these two specific objects m1 and m2 can still be distinguished and grouped into two groups due to their different z coordinates by using 3D camera according to the present invention. It should be noted that the order of steps S104 and S106 may be reversed.

Then, step S108 compares the correlative coordinate values of each of groups with the correlative coordinate values of the 3D images of the specific objects to determine the number of specific objects in the region. Please refer to FIGS. 3B and 3C, wherein the images of “human beings” in FIG. 3B will develop a particular pattern in FIG. 3C after step S104, where, in FIG. 3C, the portion corresponding to the “head” and “body” of the human beings has much more data than the portion corresponding to the “limbs” of the human beings. The correlative coordinate values of the 3D images of the specific objects (e.g., human beings) having various poses can be stored in a database in advance. By comparing the correlative coordinate values of the 3D images of various unknown objects in the region shot by cameras with the correlative coordinate values of the 3D image of the human beings stored in the database, the number of human beings can be easily determined.

In some embodiments, the 3D spatial correlative coordinate values are maped to 2D correlative coordinate values, and the database accordingly stores the 2D correlative coordinate values. The method in this case will similarly perform the comparing step S108 by using the stored 2D data as discussed in the above embodiment.

Since the distance between an object and the 3D camera shooting the object will influence the size of the object in the image shot (the farther the object is away from the camera, the smaller it is in the image), the present method can further adaptively adjust the size of the shot object in the image according to its z coordinate before performing the other procedures mentioned above. The adjusting step will not be further discussed for brevity.

The present method further provides a range of the region for counting, where the mapping step S102 is only performed on the pixels within the range of the region for counting. In one embodiment, the range of the region for counting is set to range from z=0 to z=b1, then only the pixels with z coordinates lower than the value b1 will be further processed by the mapping step S102. In another embodiment, the range of the region for counting is set as follows: c1<x<c2, c3<y≦c4, c5<z<c6, and then only the pixels within the range of the region for counting will be further processed by the mapping step S102.

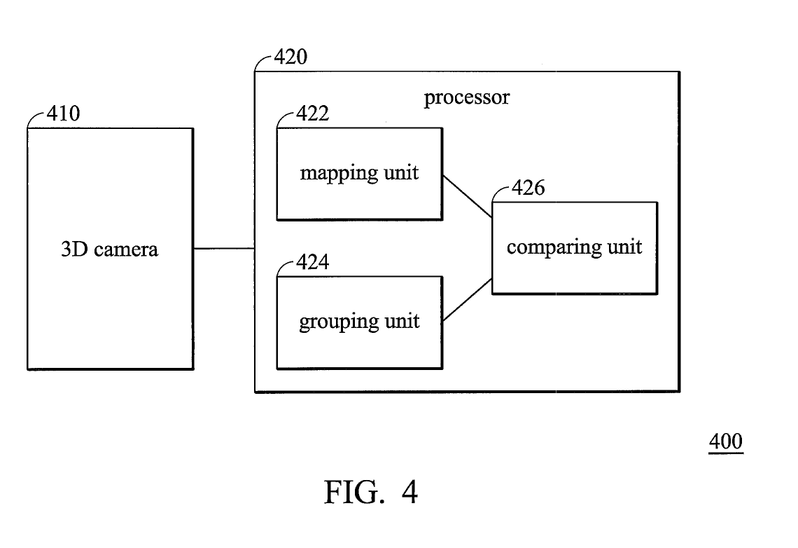

In addition to the image counting method, the present invention further provides an image counting apparatus. FIG. 4 is a schematic diagram of the image counting apparatus according to an embodiment of the present invention. The image counting apparatus 400 comprises a 3D camera 410 and a processor 420. The 3D camera 410 is used for acquiring 3D images from the region, where the 3D images comprise a plurality of pixels, and the pixels have x, y and z coordinate values and pixel data. The processor 420 further comprises a mapping unit 422, a grouping unit 424 and a comparing unit 426. The mapping unit 422 of the present invention is used for mapping the x, y and z coordinate values and the pixel data of the pixels to a plurality of correlative coordinate values of a spatial correlative coordinate represented as (x, z, t), wherein t is the number of pixels at the same coordinates (x, z) having pixel data lower than a threshold in a y direction. The grouping unit 424 of the present invention is used for grouping the correlative coordinate values into a plurality of groups according to a correlation between each of the correlative coordinate values. The comparing unit 426 of the present invention is used for comparing the correlative coordinate values of each of groups with the correlative coordinate values of the 3D images of the specific objects to determine the number of specific objects in the region. In addition, the image counting apparatus 400 further comprises a database 430. The database 430 is coupled to the processor 420 for storing the correlative coordinate values of the 3D images of the specific objects in the correlation coordinate. Since the image counting apparatus 400 can perform the same steps S102˜S108 of the image counting method described previously, and achieve the same effects, those skilled in the art can employ the image counting apparatus 400 by referring to the embodiments in regard to the image counting method. Therefore, the embodiments in regard to the image counting apparatus 400 will not be further discussed for brevity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image counting method for counting the number of specific objects in a region, comprising the steps of:
acquiring a 3D image from the region by a 3D camera, wherein the 3D images comprise a plurality of pixels, and the pixels have x, y and z coordinate values and pixel data;
mapping the x, y and z coordinate values and the pixel data of the pixels to a plurality of correlative coordinate values of a spatial correlative coordinate represented as (x, z, t), wherein t is the number of pixels whose pixel data lower than a threshold in y direction with the same x and z coordinate values;
grouping the correlative coordinate values into a plurality of groups according to a correlation between each of the correlative coordinate values in x-z plane; and
comparing the correlative coordinate values of each of groups with the correlative coordinate values of the 3D images of the specific objects to determine the number of specific objects in the region.

2. The image counting method as claimed in claim 1, wherein the pixel data of the pixel is one of the gray-level value, brightness value and RGB value of the pixel.

3. The image counting method as claimed in claim 2, wherein the gray level value is obtained by gray scaling the RGB value.

4. The image counting method as claimed in claim 1, wherein the step of comparing the correlative coordinate values of each of groups with the correlative coordinate values of the 3D images of the specific objects to determine the number of specific objects in the region further comprises:
mapping the correlative coordinate values of each group to a plurality of 2D correlative coordinate values of a 2D correlation coordinate represented as (x, t); and
comparing the 2D correlative coordinate values of each group with the 2D correlative coordinate values of the specific objects to determine the number of specific objects in the region, wherein the 2D correlative coordinate values of the specific objects are mapped from the correlative coordinate values of the specific objects and are represented as (x, t).

5. The image counting method as claimed in claim 4, wherein the step of comparing the 2D correlative coordinate values of each group with the 2D correlative coordinate values of the specific objects is to determine whether a group corresponds' to the specific objects based on the likeness of the 2D correlative coordinate values thereof, and to count the number of groups determined to correspond to the specific objects as the number of specific objects in the region.

6. The image counting method as claimed in claim 1, wherein the step of grouping the correlative coordinate values into a plurality of groups according to a correlation between each of the correlative coordinate values comprises:
grouping together every two correlative coordinate values which have a correlation which is larger than a predetermined value into the same group.

7. The image counting method as claimed in claim 1, further comprising:
providing a database for storing the correlative coordinate values of the 3D images of the specific objects in the correlation coordinate.

8. The image counting method as claimed in claim 1, further comprising:
providing a range of the region for couting, wherein the mapping step is only performed to the pixels in the range of the region.

9. An image counting apparatus for counting the number of specific objects in a region, comprising:
a 3D camera for acquiring a 3D image from the region, wherein the 3D images comprise a plurality of pixels, and the pixels have x, y and z coordinate values and pixel data; and
a processor, coupled to the 3D camera, comprising:
a mapping unit for mapping the x, y and z coordinate values and the pixel data of the pixels to a plurality of correlative coordinate values of a spatial correlative coordinate represented as (x, z, t), wherein t is the number of pixels whose pixel data are lower than a threshold in y direction with the same x and z coordinate values;
a grouping unit for the correlative coordinate values into a plurality of groups according to a correlation between each of the correlative coordinate values in x-z plane; and
a comparing unit for comparing the correlative coordinate values of each of groups with the correlative coordinate values of the 3D images of the specific objects to determine the number of specific objects in the region.

10. The image counting apparatus as claimed in claim 9, wherein the gray level value is obtained by gray scaling the RGB value.

11. The image counting apparatus as claimed in claim 9 wherein the pixel data of the pixel is one of the gray-level value, brightness value and RGB value of the pixel.

12. The image counting apparatus as claimed in claim 9, wherein the comparing unit further changes the correlative coordinate values of each of the groups to a plurality of 2D correlative coordinate values of a 2D correlation coordinate represented as (x, t), and then compares the 2D correlative coordinate values of the groups with the 2D correlative coordinate values of the specific objects to determine the number of specific objects in the region, wherein the 2D correlative coordinate values of the specific objects are mapped from the correlative coordinate values of the specific objects and are represented as (x, t).

13. The image counting apparatus as claimed in claim 12, wherein the comparing unit determines whether a group corresponds to the specific objects based on the likeness of the 2D correlative coordinate values thereof, and counts the number of groups determined to correspond to the specific objects as the number of specific objects in the region.

14. The image counting apparatus as claimed in claim 9, wherein the grouping unit groups together two correlative coordinate values which have a correlation which is larger than a predetermined value.

15. The image counting apparatus as claimed in claim 9, further comprises a database, coupled to the processor, for storing the correlative coordinate values of the 3D images of the specific objects in the correlation coordinate.

16. The image counting apparatus as claimed in claim 9, wherein the counting unit further comprises a range of the region for couting, wherein the mapping unit only maps the x, y and z coordinate values and the pixel data of the pixels in the range of the region to the correlative coordinate values in the spatial correlative coordinate.
